(19) United States
(12) Patent Application Publication
(10) Pub. No.: US 2023/0227669 A1
(43) Pub. Date: Jul. 20, 2023

(54) ORGANOMETALLIC COMPLEX COATING SOLUTION AND NEAR INFRARED ABSORPTION FILM

(71) Applicant: PLATINUM OPTICS TECHNOLOGY INC., Taoyuan City (TW)

(72) Inventors: Feng-Ling WU, Taoyuan City (TW); Shih-Song CHENG, Taoyuan City (TW); Tang-Hao YANG, Taoyuan City (TW); Tzu-Ling CHAO, Taoyuan City (TW); Bo-Xun ZHU, Taoyuan City (TW); Hsing-Hui LIN, Taoyuan City (TW); Kuo-Chen LI, Taoyuan City (TW); Chang-Jun LIN, Taoyuan City (TW)

(21) Appl. No.: 18/155,564

(22) Filed: Jan. 17, 2023

(30) Foreign Application Priority Data
Jan. 19, 2022 (TW) 111102215

(51) Int. Cl. C09D 5/32; C09D 7/45; C09D 7/65; C09D 7/63; C09D 169/00; C09D 183/04; G02B 5/20; G02B 1/04

(52) U.S. Cl. CPC C09D 5/32; C09D 7/45; C09D 7/65; C09D 7/63; C09D 169/00; C09D 183/04; G02B 5/208; G02B 1/04

(57) ABSTRACT

Provided are an organometallic complex coating solution and a near-infrared absorption film, including an organometallic complex, a phosphorus-containing dispersant, and optical resin. The present disclosure greatly reduces the temperature and time of the film-forming process by formulating components of the organometallic complex coating solution.

### BACKGROUND

### Technical Field

The present disclosure relates to an organometallic complex coating solution, especially a near-infrared absorption film formed from the organometallic complex coating solution.

### Description of Related Art

The advances and trends toward the portability of electronic devices have led to a remarkable demand for miniaturized electronic components that are light, thin, short, small, and the like. The rapid development of resin-type absorptive near-infrared (NIR) cutoff filters formed using organometallic complex coating solution is primarily due to the issue of balancing thinning and infrared absorption for glass substrates used as absorptive NIR cutoff filters. In resin-type absorptive NIR cutoff filters, an organometallic complex dispersion is mixed with resin components to form a coating solution, and then coated on a substrate to form a NIR absorption film. The optical performance of the NIR absorption film may be largely improved by a specific formulation, such as strong absorption of NIR at wavelengths between 800 nm and 1100 nm, especially excellent absorption of NIR at a wavelength of 940 nm, resulting in a NIR cutoff filter with excellent cutoff effects.

In the process of applying the organometallic complex coating solution on a substrate, titanium catalysts are added and the mixture is cured to form a film at 85° C. and 140° C. conventionally. However, the added catalysts may deteriorate the NIR absorption film under high-temperature baking, for example, the deterioration of visible light transmittance due to haze. On the other hand, even though the curing process is conducted at a high temperature, it still takes several hours or more, resulting in low productivity and high cost that both are unfavorable for large-scale production. As a result, there is a need to further improve the temperature and time of the coating process while retaining the excellent optical performance of the NIR absorption film, and without adding catalysts.

### SUMMARY

For the above-mentioned problems to be solved, the present disclosure provides an organometallic complex coating solution comprising:

an organometallic complex;

a phosphorus-containing dispersant; and

an optical resin.

Said optical resin is a thermoplastic resin, a photocurable resin or a mixture thereof. Said thermoplastic resin is at least one selected from polycarbonate, polyester, and polycyclic olefin. Specifically, said polycarbonate has a structure of:

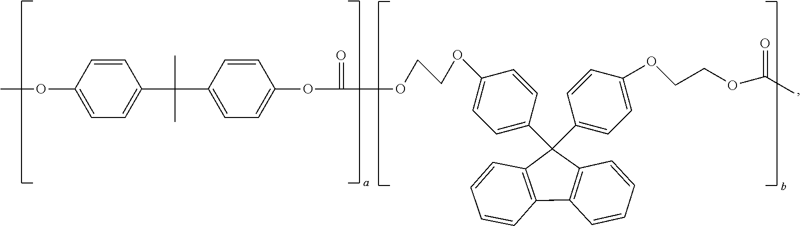

said polyester has a structure of:

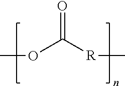

said polycyclic olefin has a structure of:

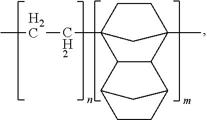

wherein R is an alkylene group or an arylene group, and the alkylene group is linear, branched, cyclic or a combination thereof, wherein a and b are each independently an integer from 4 to 9, and n and m are each independently an integer from 20 to 30.

Said photocurable resin is at least one selected from an acrylic resin, a silicone-based resin and an imide-based resin. In one embodiment, the silicone-based resin has a structure of [R¹SiO_{3/2}]ₓ, wherein R¹ is

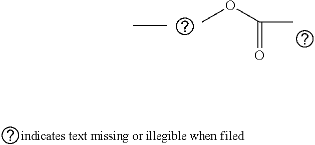

an integer from 3 to 40.

The present disclosure further provides a NIR absorption film formed from the organometallic complex coating solution, that is to say, the NIR absorption film comprises:

an organometallic complex;

a phosphorus-containing dispersant; and

an optical resin.

The organometallic complex coating solution of the present disclosure can be coated on a substrate and baked to form a film without adding a catalyst. Moreover, the temperature and time for the film formation process are also significantly lower than those of the prior art. Accordingly, the advantageous effects such as improved productivity, energy saving and carbon reduction, reduced costs, promoted profits, and improved quality is achieved, thereby helping the industry to pass increasingly stringent environmental protection certifications and expand the market.

The NIR absorption film formed from the organometallic complex coating solution has excellent optical performance, for example, high transmittance in the visible region and extremely low transmittance in the NIR region in the case of thin thickness, showing the excellent NIR cut-off effect.

### BRIEF DESCRIOPTION OF THE DRAWINGS

FIG. 1 is a graph showing the transmittance of the NIR absorption film of Example 1 of the present disclosure to the light with various wavelengths under various thermoplastic resin contents.

FIG. 2 is a graph showing the transmittance of the NIR absorption film (containing photocurable resin) of Example 2 of the present disclosure to the light with various wavelengths under various film thicknesses.

FIG. 3 is a graph showing the transmittance of the NIR absorption film of Example 2 of the present disclosure to the light with various wavelengths under various photocurable resin contents.

### DETAILED DESCRIPTIONS

The following describes the implementation of the present disclosure with embodiments. Those skilled in the art can easily understand the scope and effects of the present disclosure from the contents disclosed in this specification. However, the embodiments set forth herein are not intended to limit the present disclosure, and the listed technical features or solutions can be combined with each other. The present disclosure can be implemented or applied by other different embodiments, and the details described herein can also be given different changes or modifications based on different viewpoints and applications without departing from the present disclosure.

When “comprising,” “including,” or “having” an element described herein, unless otherwise specified, other elements, components, structures, regions, parts, devices, systems, steps, or connection relationships may be further included, rather than excluding those other elements.

Unless otherwise specified, the singular forms “a” and “the” described herein also include the plural forms, and “or” and “and/or” described herein are used interchangeably.

Numerical ranges described herein are inclusive and combinable, and any numerical value falling within the numerical range described herein may be taken as a maximum or minimum value to derive a sub-range; for example, a numerical range of “1.5/8.5 to 0.5/9.5” should be deemed to include any sub-range between a minimum value of 1.5/8.5 and a maximum value of 0.5/9.5, for example, sub-ranges of 1.4/8.6 to 0.5/9.5, 1.5/8.5 to 0.6/9.4, 1.4/8.6 to 0.6/9.4 and others; in addition, if a value falls within each range described herein (e.g., between the maximum and minimum values stated), it shall be deemed to be included in the present disclosure.

The first aspect of the present disclosure is directed to an organometallic complex coating solution, comprising:

an organometallic complex;

a phosphorus-containing dispersant; and

an optical resin.

Said organometallic complex, such as an organometallic complex formed from a copper compound and a phosphonic acid. In an embodiment, the copper compound is a copper salt, which may be listed as an anhydride or hydrate of copper acetate, copper chloride, copper formate, copper stearate, copper benzoate, copper pyrophosphate, copper naphthenate, copper citrate. In one embodiment, the structure of the phosphonic acid may be represented by RPO(OH)₂, wherein R is alkyl, haloalkyl, phenyl, halophenyl, nitrophenyl, hydroxyphenyl, alkylphenyl, haloalkylphenyl, nitroalkylphenyl, or hydroxyalkylphenyl. In a further embodiment, the copper compound is copper acetate and the phosphonic acid is butylphosphonic acid. The organometallic complex is a NIR absorber.

Said phosphorus-containing dispersant can be at least one selected from a phosphoric acid derivative, a phosphonic acid derivative (and/or its tautomer phosphorus acid derivative), and a phosphinic acid derivative (and/or its tautomer hypophosphorus acid derivative). In an embodiment, the phosphorus-containing dispersant has an alkyl group and/or a polyoxyalkyl group. In a further embodiment, the phosphorus-containing dispersant is, for example, Plysurf A208N (polyoxyethylene alkyl (C12,13) ether phosphate), Plysurf A208F (polyoxyethylene alkyl (C8, i.e., (2-ethylhexyl)) ether phosphate), Plysurf A208B (polyoxyethylene lauryl ether phosphate), Plysurf A219B (polyoxyethylene lauryl ether phosphate), Plysurf AL (polyoxyethylene styrylated phenyl ether phosphate), Plysurf A212C (polyoxyethylene tridecyl ether phosphate) and Plysurf A215C (polyoxyethylene tridecyl ether phosphate) manufactured by DKS Co., Ltd., NIKKOL DDP-2 (di-C12-C15 alkanol polyether-2 phosphate), NIKKOL DDP-4 (di-C12-C15 alkanol polyether-4 phosphate), NIKKOL DDP-6 (di-C12-C15 alkanol polyether-6 phosphate) manufactured by Nikko Chemical Co., bis(2,4,4-trimethylpentyl)phosphinic acid, etc. The phosphorus-containing dispersant is used to suitably disperse the NIR absorber to enhance its NIR absorption effect. Since the phosphorus-containing dispersant is added at the stage of synthesizing the organometallic complex, it participates in the reaction. Thereby, the phosphorus-containing dispersant and the organometallic complex are deemed to be an overall organometallic complex in the present disclosure, i.e., the total weight of the phosphorus-containing dispersant and the organometallic complex is the total weight of the overall organometallic complex.

In the present disclosure, the organometallic complex coating solution is specifically formed by mixing the organometallic complex dispersion containing the aforementioned organometallic complex and phosphorus-containing dispersant with an optical resin.

In an embodiment, the organometallic complex dispersion further comprises a solvent, which may be selected from known solvents, including but not limited to water, alcohols, ketones, ethers, esters, aromatic hydrocarbons, halogenated hydrocarbons, dimethylformamide, dimethylacetamide, dimethyl sulfoxide, or tetramethylene sulfone, etc. Specifically, the alcohols may be methanol, ethanol, propanol, etc. The esters may be alkyl formate, alkyl acetate, alkyl propionate, alkyl butyrate, alkyl lactate, alkoxy acetate, alkyl 3-alkoxypropionate, alkyl 2-alkoxypropionate, alkyl 2-alkoxy-2-methylpropionate, alkyl pyruvate, alkyl acetoacetate, alkyl 2-oxobutyrate, etc. The ethers may be diethylene glycol dimethyl ether, tetrahydrofuran, ethylene glycol monomethyl ether, ethylene glycol monoethyl ether, methylene glycol monoethyl acetate, ethylene glycol monoethyl acetate, diethylene glycol monomethyl ether, diethylene glycol monoethyl ether, diethylene glycol monobutyl ether, propylene glycol monomethyl ether, propylene glycol monomethyl ether acetate, propylene glycol monoethyl ether acetate, propylene glycol monopropyl ether acetate, etc. The ketones may be methyl ethyl ketone, cyclohexanone, cyclopentanone, 2-heptanone, 3-heptanone, etc. The aromatic hydrocarbons, such as toluene, or xylene.

In an embodiment, the optical resin of the present disclosure is a thermoplastic resin, a photocurable resin, or a mixture thereof.

In an embodiment, the thermoplastic resin is at least one selected from polycarbonate, polyester and polycyclic olefin.

Said polycarbonate has a dicarboxylic acid structural unit and a diol structural unit. In an embodiment, the dicarboxylic acid structural unit may include a 9,9-diphenylfluorenyl group, and the 9,9-diphenylfluorenyl group may have substituents on the benzene ring, including but not limited to C1-C10 alkyl and halogen; and the diol structural unit may include a bisphenol A group (2,2-bis(4-hydroxyphenyl)propane), and the bisphenol A group may have substituents on the benzene ring, including but not limited to C1-C4 alkyl, halogen and phenyl. In an embodiment, said polycarbonate has a structure of:

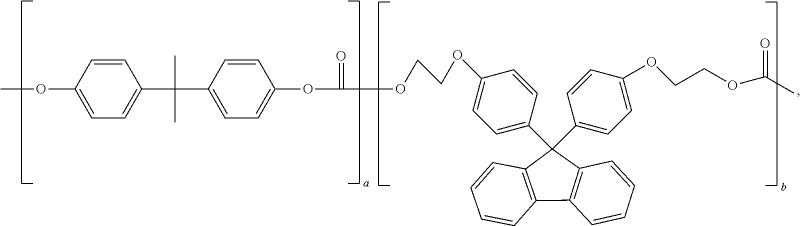

wherein a and b are each independently an integer from 4 to 9.

In an embodiment, the polyester has a structure of:

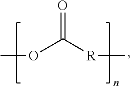

wherein R is an alkylene group having a carbon number of 4 to 8 or an arylene group having a carbon number of 6 to 30, and the alkylene group is linear, branched, cyclic or a combination thereof. The alkylene group, such as methylene group, ethylene group, propylene group, butylene group, and divalent cyclopropane group. The arylene, such as phenylene group, phenylene vinylene group, naphthylene group, divalent biphenyl group, divalent bisphenol A group, and divalent 9,9-diphenylfluorene group. In the structure, n is an integer from 20 to 30.

Said polycyclic olefin includes cycloolefin-derived structural units, such as tetracyclododecene. Besides, the polycyclic olefin may further include olefin-derived structural units, such as ethene, propene, and butene. In an embodiment, the polycyclic olefin has a structure of:

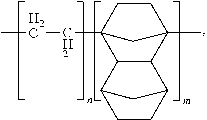

wherein n and m are each independently an integer from 20 to 30.

The photocurable resin of the present disclosure, in an embodiment, is at least one selected from an acrylic resin, a silicone-based resin and an imide-based resin. Monomers of said acrylic resin, such as methyl methacrylate, 2-hydroxyethyl methacrylate, 2-hydroxypropyl methacrylate, ethylene glycol dimethacrylate, ethyl acrylate, ethyl methacrylate, bisphenol A dimethacrylate, bisphenol A-glycidyl methacrylate, bisphenol A-ethoxylated glycidyl methacrylate. Said acrylic resin may include one monomer or more. Said silicone-based resin, in an embodiment, is a siloxane including acrylate group or methacrylate group, and specifically has a structure of [R¹SiO_{3/2}]ₓ, wherein R¹ is

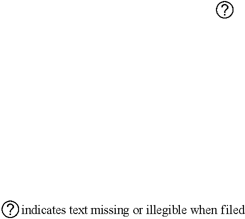

is an integer from 3 to 40. In yet another embodiment, the silicone-based resin has a half cage structure:

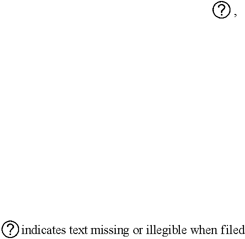

wherein R is

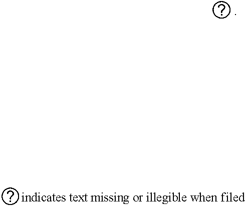

In an embodiment, the imide resin is, for example, low temperature photosensitive polyimide photoresist ETERFLEX™ EPD-3500 produced by ETERNAL CHEMICLA CO., LTD.

In the case of using the photocurable resin, a photo-curing agent may be added to the organometallic complex coating solution to facilitate the film formation in the photocuring process.

The optical resins may be in the form of powder, particles, or liquid. For example, the thermoplastic resin may be added to the organometallic complex dispersion in particle form, and for example, the photocurable resin may be in a liquid form and be mixed with the organometallic complex dispersion.

In an embodiment, the weight ratio of the overall organometallic complex (i.e., the total weight of the organometallic complex and phosphorus dispersant) to the thermoplastic resin is 0.5/9.5 to 7.5/2.5, 0.5/9.5 to 6.0/4.0, or 0.5/9.5 to 5.0/5.0, for example, the weight ratio of the overall organometallic complex to the thermoplastic resin is 0.5/9.5, 1.0/9.0, 1.5/8.5, 2.0/8.0, 2.5/7.5, 3.0/7.0, 3.5/6.5, 4.0/6.0, 4.5/5.5, 5.0/5.0, 5.5/4.5, 6.0/4.0, 6.5/3.5, 7.0/3.0, or 7.5/2.5.

In an embodiment, the weight ratio of the overall organometallic complex (i.e., the total weight of the organometallic complex and phosphorus dispersant) to the photocurable resin is 1.0/9.0 to 6.5/3.5, 1.0/9.0 to 6.0/4.0, or 1.0/9.0 to 5.0/5.0, for example, the weight ratio of the overall organometallic complex to the photocurable resin is 1.0/9.0, 1.5/8.5, 2.0/8.0, 2.5/7.5, 3.0/7.0, 3.5/6.5, 4.0/6.0, 4.5/5.5, 5.0/5.0, 5.5/4.5, 6.0/4.0, or 6.5/3.5. In the present disclosure, an effective NIR absorption is achieved with smaller amounts of the organometallic complex.

A second aspect of the present disclosure is direct to providing a NIR absorption film comprising:

an organometallic complex;

a phosphorus-containing dispersant; and

an optical resin.

Said NIR absorption film is formed from the organometallic complex coating solution of the first aspect, for example, the organometallic complex coating solution is coated on a substrate, baked by heating and then the solvent was removed, in order to film the NIR absorption film.

In general, the NIR cutoff effect is enhanced with the increase of the thickness of the NIR absorption film, which does not fulfill the needs of miniaturization; on the other hand, the NIR cutoff effect deteriorates as the thickness of the NIR absorption film decreases. In the present disclosure, the NIR absorption film surprisingly has excellent optical performance and can achieve an excellent NIR cutoff effect even at quite a small thickness. Said small thickness may refer to a thickness from 10 μm to 100 μm, from 20 μm to 90 μm, or from 50 μm to 100 μm, for example, the thickness is 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, or 100 μm. The thickness and the content of the thin film both affect film's optical performance, and the increase or decrease of the thickness may require simultaneous adjustment of the content ratio. For example, when the thickness further decreases, the amount of the organometallic complex as the NIR absorber may need to be increased and the adjustment may vary depending on different situations in actual applications.

The NIR absorption film of the present disclosure has an average transmittance of 60% to 90% to the light in the wavelength range of 400 nm to 700 nm, preferably has an average transmittance of 70% to 90% or 75% to 90%, for example, 60%, 65%, 70%, 75%, 80%, 85%, or 90%. On the other hand, the NIR absorption film has an average transmittance of 40% or less to the light in the wavelength range of 800 nm to 1100 nm, preferably has an average transmittance of 35% or less or 30% or less, for example, an average transmittance of 40%, 35%, 30%, 25%, 20%, 15%, 10%, 5%, 2.5%, 2% or less.

50% transmittance wavelength of the NIR absorption film of the present disclosure is nearby the infrared region so that the NIR absorption film maintains a high level of the average transmittance to the light in the visible region. Said 50% transmittance wavelength refers to the wavelength of incident light at which the NIR absorption film of the present disclosure exhibits 50% transmittance. In the case of a plurality of 50% transmittance wavelength, 50% transmittance wavelength in the present disclosure specifically refers to that nearby the NIR region, more specifically, that between the visible region and the NIR region. Specifically, 50% transmittance wavelength is 700 nm or more, 710 nm or more, or 720 nm or more, for example, 50% transmittance wavelength is 700 nm, 705 nm, 710 nm, 715 nm, 720 nm, 725 nm, or 730 nm.

On the other hand, for currently widely used biometric light sources with a wavelength of 940 nm, the NIR absorption film of the present disclosure also exhibits an excellent cut-off effect. Specifically, the transmittance of the NIR absorption film to the light with a wavelength of 940 nm is 40% or less, preferably, 35% or less, or 30% or less, for example, 40%, 35%, 30%, 25%, 20%, 15%, 10%, 5%, 2.5%, 2% or less.

The present disclosure may be described in further detail according to the following examples, however, the examples are not intended to limit the scope of the disclosure.

### EXAMPLE 1

Firstly, copper acetate was mixed with ethanol at a ratio of 1 g/100 g and then stirred at room temperature for 1.5 hours to form a first mixed solution. Further, 0.5 g of Plysurf A208F (polyoxyethylene 2-ethylhexyl ether phosphate, DKS Co., Ltd.), 0.25 g of Plysurf A212C (polyoxyethylene tridecyl ether phosphate, DKS Co., Ltd.), 0.2 g of NIKKOL DDP-6 (di-C12-C15 alkanol polyether-6 phosphate, Nikko Chemical Co.), and 0.2 g of bis(2,4,4-trimethylpentyl) phosphinic acid were mixed with 10 g of ethanol to form a second mixed solution. The first mixed solution was mixed with the second mixed solution and stirred at room temperature for 1 hour. Then, 0.6 g of butylphosphonic acid was added and stirred at room temperature for 3 hours, followed by being placed into an oven at 85° C. for 12 hours to form an overall organometallic complex. The product was added to toluene to form a dispersion. Next, a thermoplastic resin polycarbonate (APEL 401C, purchased from Mitsui Chemicals, Inc.) was used as an optical resin, the optical resin and the dispersion were mixed according to the 6 ratios listed in Table 1 to form an organometallic complex coating solution. The organometallic complex coating solution was then coated on a transparent glass substrate and baked at 70° C. for 30 minutes. It was observed that 6 kinds of the organometallic complex coating solution obtained from the aforementioned thermoplastic resin and the dispersion all cured to form the NIR absorption films. The haze of the obtained NIR absorption films was tested, and the results are shown in Table 1 as follows.

TABLE 1

| | Weight of overall organometallic complex/weight | | | | | |
|---|---|---|---|---|---|---|
| | of thermoplastic resin | | | | | |
| | 5.0/5.0 | 3.5/6.5 | 2.5/7.5 | 1.5/8.5 | 1.0/9.0 | 0.5/9.5 |
| Film | Yes | Yes | Yes | Yes | Yes | Yes |
| formation | | | | | | |
| Haze* | 35%-50% | 35%-50% | 35%-50% | ≤35% | ≤35% | ≤35% |

*Haze = [diffusion transmittance (T_{diff})/total transmittance (Tₜ)] × 100%

According to the above table, the organometallic complex coating solution of the present disclosure allows film formation under the severe conditions of no catalyst, low temperature, and short reaction time. The haze value is influenced by the weight ratio of the organometallic complex and the phosphorus-containing dispersant to thermoplastic resin particles, but this can be adjusted depending on requirements during application. Generally, a haze value of 60% or less is acceptable. Under the most preferred condition, a much lower haze value can be used to enhance the overall transmittance.

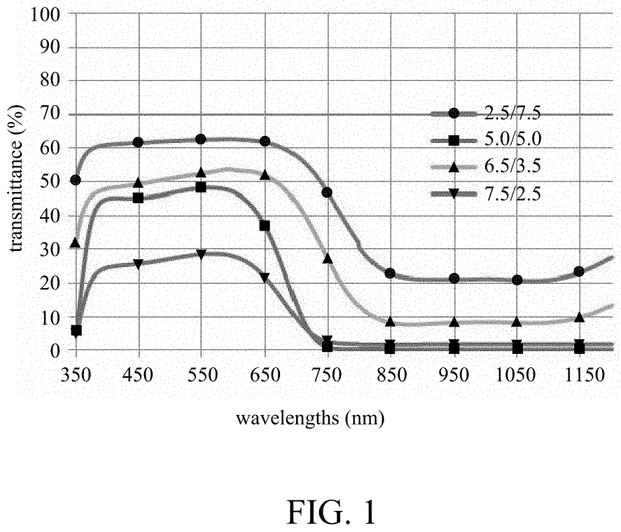

FIG. 1 shows a transmittance graph of the NIR absorption films having the same thickness that formed from the organometallic complex coating solution, wherein the weight ratio of the overall organometallic complex (i.e., the total weight of the organometallic complex and the phosphorus-containing dispersant) to the thermoplastic resin polycarbonate APEL 401C is 7.5/2.5, 6.5/3.5, 5.0/5.0, and 2.5/7.5. The results of FIG. 1 show that the NIR absorption film having a weight ratio of 2.5/7.5 can achieve an average transmittance of 40% or less (about 32%) to the light in a wavelength range of 800 nm to 1100 nm, which is sufficient to meet the product requirements. If the amount of the overall organometallic complex is more, the average transmittance of the NIR film to the light in a wavelength range of 800 nm to 1100 nm can be further reduced, such as to 10% or less, 5% or less, even about 3% or 2%, which is more suitable for products with higher requirements for filtering infrared. The organometallic complex is used for infrared absorption, but increasing its amount would also affect the transmittance in the visible region. In practical applications, the content ratio and the thickness can be adjusted to control the desired transmittance. Besides, although the thermoplastic resin is polycarbonate (APEL 401C from Mitsui Chemicals) in this example, polyester (P-3810, purchased from Teijin Chemical) polycyclic olefin (ZEONEX K22R, purchased from ZEON), or a mixture of any two or three of the above-mentioned thermoplastic resins may be used in other examples without affecting the optical performance of the resulting film.

### EXAMPLE 2

A dispersion was prepared according to Example 1, whereas the photocurable resin:

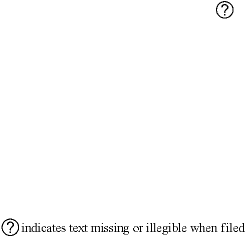

### (R is

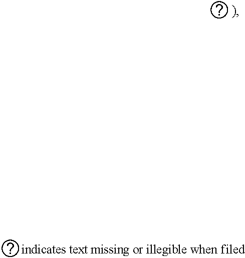

was added into the dispersion and 0.2 wt % to 10 wt % of a photo-curing agent omnirad 1173 (purchased from IGM Resins) was added, to form an organometallic complex coating solution. Then, the organometallic complex coating solution was coated on a transparent glass substrate, baked at a temperature of 70° C. for 5 minutes and irradiated by UV for 60 seconds. The results of film formation were then observed.

TABLE 2

| | | |
|---|---|---|
| Weight of overall organometallic complex/ | 5.0/5.0 | 6.5/3.5 |
| weight of photocurable resin | | |
| Film formation | Yes | Yes |

The results show that the time required for film formation by using the organometallic complex coating solution of the present disclosure is shorter when the photocurable resin is used.

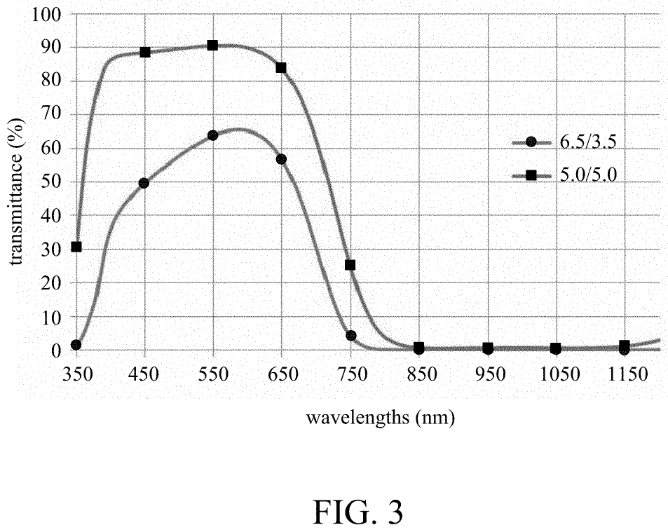

FIG. 3 shows a transmittance graph of the NIR absorption films having the same thickness that formed from the organometallic complex coating solution, wherein the weight ratio of the overall organometallic complex (i.e., the total weight of the organometallic complex and the phosphorus-containing dispersant) to the photocurable resin is 6.5/3.5 and 5.0/5.0. The results of FIG. 3 show that the NIR absorption film having a weight ratio of 5.0/5.0 can achieve a quite high average transmittance (up to 85% or more) the light in a wavelength range of 400 nm to 700 nm, and relatively a quite low average transmittance (to about 2%) to the light in a wavelength range of 800 nm to 1100 nm. In the group with a weight ratio of 6.5/3.5, the average transmittance to the light in a wavelength range of 800 nm to 1100 nm further decreases but to the light in a wavelength range of 400 nm to 700 nm is also influenced and therefore decreases. Similar to Example 1, the content ratio and the thickness can be adjusted to control the desired transmittance.

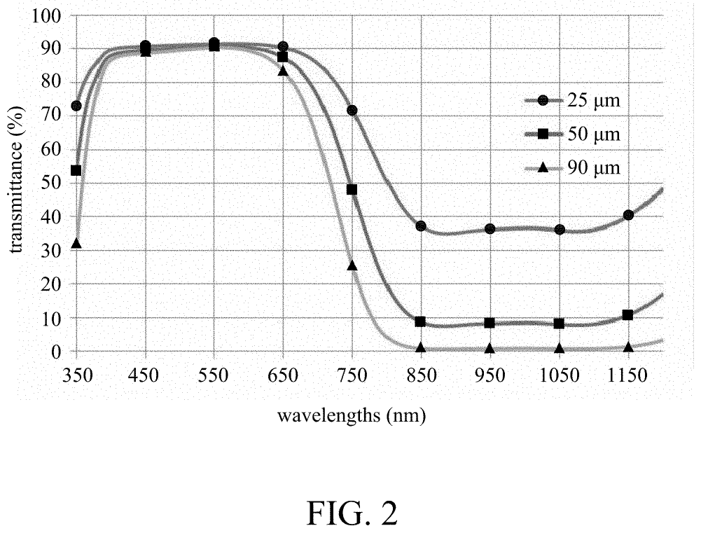

Particularly, the NIR absorption film of the present disclosure also exhibits excellent optical performance even with a small thickness. As shown in FIG. 2, the NIR absorption film containing the overall organometallic complex and the photocurable resin (with a weight ratio of 5.0/5.0) has an excellent NIR cutoff effect with a thickness of merely 90 and it shows the average transmittance of 88% or more to the light in a wavelength range of 400 nm to 700 nm and the average transmittance of about 2% to the light in a wavelength range of 800 nm to 1100 nm. If the thickness further decreases, for example, to 50 the NIR cut-off effect tends to decrease, however, the MR absorption film still shows an average transmittance of 10% or less to the light in a wavelength range of 800 nm to 1100 nm, which can be applied in various products. If the thickness further decreases more, for example, to 25 the NIR film still shows an average transmittance of 40% or less to the light in a wavelength range of 800 nm to 1100 nm. In addition, in the cases of lower thickness, the NIR absorption effect can be further enhanced through adjusting the ratio of the (overall) organometallic complex and the photocurable resin.

In the conventional organometallic complex coating solution, in order to enhance NIR absorption, the organometallic complex and dispersant account for a larger proportion in the coating solution, usually 75 wt % or 65 wt %. In contrast, through the improvement of the coating solution in the present disclosure, it is found that a relatively small amount of the overall organometallic complex can achieve the outstanding NIR absorption effect by using a certain optical resin component. For example, the weight ratio of the overall organometallic complex to the optical resin (thermoplastic resin) in Example 1 is 2.5/7.5, and the average transmittance to the light in a wavelength range of 800 nm to 1100 nm can be reduced to 40% or less, which achieves the sufficient NIR absorption and thereby can be applied in products; further, in the case of using a larger amount of the overall organometallic complex, for example, in a weight ratio of 5.0/5.0 or 7.5/2.5, the NIR absorption is further enhanced, and the NIR absorption film can be applied in products with higher requirements for filtering infrared.

The optical resin used in the present disclosure only functions as a carrier and does not undergo cross-linking polymerization with the (overall) organometallic complex during film formation, and thereby the thermoplastic resin and photocurable resin can be mixed to use as the optical resin without affecting the performance of the resulting film, which is different from the conventional film formation process. Besides, since the optical resin does not involve the polymerization/crosslinking reaction, there is no loss of the (overall) organometallic complex and the amount of the (overall) organometallic complex can be significantly reduced.

Moreover, compared to the prior art that requires a higher temperature and stepwise baking process at different temperatures (e.g., baking at 80° C. for 30 minutes followed by baking at 140° C. for 2 hours), the optical resin used in the present disclosure easily accomplishes the film formation at a temperature of 70° C. for 30 minutes, so the formulation and the method of the present disclosure gives the advantages such as saving energy consumption and efficient production and are extremely suitable for mass production. Such outstanding effects are also presumed to be due to no polymerization/crosslinking reaction between the (overall) organometallic complex and the optical resin, in which the optical resin only serves as a carrier, and thereby only a lower temperature and shorter reaction time are required.

What is claimed is:

1. An organometallic complex coating solution, comprising:
an organometallic complex;
a phosphorus-containing dispersant; and
an optical resin.

2. The organometallic complex coating solution of claim 1, wherein the optical resin includes a thermoplastic resin.

3. The organometallic complex coating solution of claim 2, wherein the thermoplastic resin is at least one selected from polycarbonate, polyester and polycyclic olefin.

4. The organometallic complex coating solution of claim 3, wherein
the polycarbonate has a structure of: 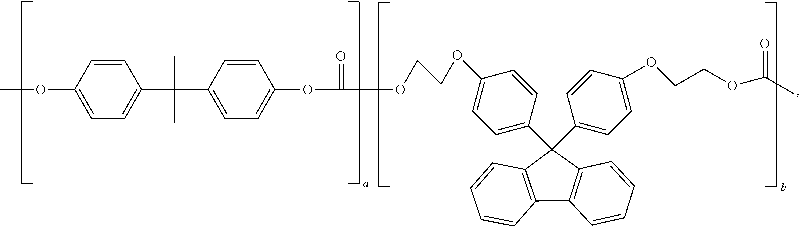
wherein a and b are each independently an integer from 4 to 9;
the polyester has a structure of: 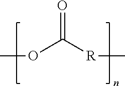
the polycyclic olefin has a structure of: 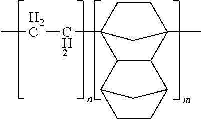
wherein R is an alkylene group having a carbon number of 4 to 8 or an arylene group having a carbon number of 6 to 30, the alkylene group is linear, branched, cyclic or a combination thereof, and n and m are each an integer from 20 to 30.

5. The organometallic complex coating solution of claim 4, wherein the thermoplastic resin is the polyester, R is at least one selected from the group consisting of methylene group, ethylene group, propylene group, butylene group, divalent cyclopropane group, phenylene group, phenylene vinylene group, naphthylene group, divalent biphenyl group, divalent bisphenol A group, and divalent 9,9-diphenylfluorene group.

6. The organometallic complex coating solution of claim 2, wherein the weight ratio of the organometallic complex and the phosphorus-containing dispersant to the thermoplastic resin is from 0.5/9.5 to 7.5/2.5.

7. The organometallic complex coating solution of claim 1, wherein the optical resin includes a photocurable resin.

8. The organometallic complex coating solution of claim 7, wherein the photocurable resin is at least one selected from an acrylic resin, a silicone-based resin and an imide-based resin.

9. The organometallic complex coating solution of claim 8, wherein the silicone-based resin has a structure of [R¹SiO_{3/2}]ₓ, wherein R¹ is 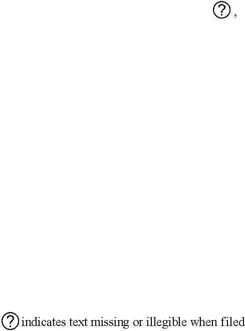
and
x is an integer from 3 to 40.

10. The organometallic complex coating solution of claim 7, wherein the weight ratio of the organometallic complex and the phosphorus-containing dispersant to the photocurable resin is from 1.0/9.0 to 6.5/3.5.

11. The organometallic complex coating solution of claim 1, wherein the optical resin includes a thermoplastic resin and a photocurable resin.

12. A near-infrared absorption film formed from the organometallic complex coating solution according to claim 1.

13. The near-infrared absorption film of claim 12, having a thickness of from 10 μm to 100 μm, an average transmittance of 60% to 90% to the light in the wavelength range of from 400 nm to 700 nm, and an average transmittance of 40% or less to the light in the wavelength range of from 800 nm to 1100 nm.

14. The near-infrared absorption film of claim 12, wherein 50% transmittance of the near-infrared absorption film occurs at a wavelength of 700 nm or more.
